(19) United States
(12) Patent Application Publication
(10) Pub. No.: US 2012/0144725 A1
(43) Pub. Date: Jun. 14, 2012

(54) Fishing line cutter

(76) Inventor: Pete Marascalco, Grenada, MS (US)

(21) Appl. No.: 12/928,433

(22) Filed: Dec. 13, 2010

(51) Int. Cl. A01K 97/00; A01K 87/00

(52) U.S. Cl. 43/25

(57) ABSTRACT

A fishing line cutter that is integral to a fishing pole. The fishing line cutter comprises a tubular section with an arcuate projection. The arcuate projection may extend from a same side as a reel mounted on the fishing pole. A spring means may springingly attach the arcuate projection to a slot. The slot can accommodate the arcuate projection upon depression into the fishing pole. An O-ring may be employed to slide along the fishing pole and facilitate depression of the arcuate projection. At least one sharpening means may be included in the fishing line cutter to maintain sharpness.

### TECHNICAL FIELD

The field to which the disclosure generally relates includes a fishing pole, in particular a fishing line cutter integral to the fishing pole that is suitable for being used to cut a fishing line.

### BACKGROUND

It is generally known and recognized that the use of a fishing rod, line and tackle frequently involves a variety of tools and apparatus to aid in accomplishing certain tasks. However, a particular problem is involved in the changing of a lure while fishing. In this connection, the fisherman must locate the needed clippers or pliers in his tackle box and, thereafter, cut the fishing line and remove the lure. At this point, the line is free to fly in the wind and is sometimes difficult to retrieve. Because the fisherman generally uses both hands to remove the lure from the fishing line and select a new lure, it is difficult to hold the unsecured fishing line during the procedure. Some fishermen carry a knife in their tackle boxes to cut the line. Others carry an old razor blade. Some even carry a fingernail clipper or other line cutting means.

Many other cutting devices have been used, all of which first must be located in the tackle box and held by hand during use in cutting. Most such prior cutting instruments that are located in a fisherman's tackle box are frequently under fish lures, fish hooks, reels, or other items of tackle and it is difficult to find the cutting device. Moreover, knives, razor blades, clippers or other prior cutting devices require that the fisherman hold the cutting device in his hand while his hand is needed for use of other purposes at the time.

Thus, various methods and devices have been historically suggested for restraining or holding the line when winding a new one, threading line through small eyelets, clasping the line for attaching lures and hooks, or cutting the line for removing or replacing lures, hooks or the like. Many fishing line cutters that have a blade or blades for cutting a line are removably attachable to a fishing pole or a fishing reel. In U.S. Pat. No. 7,389,607 a fishing line cutter is described that is made as a single piece and is obtained by cutting out and stamping a metal plate. The fishing line cutter is secured to the body of the fishing rod by binding or whipping two longitudinal prongs located on the metal plate to the body. U.S. Pat. No. 5,182,874 describes a fishing line cutter that includes a body member to which is mounted an implement with a sharp edge or edges. The body member includes projections for facilitating the mounting of the cutter on a fishing pole. However, prior to the present invention, there is no fishing line cutter that is attached integrally to the fishing pole.

Thus, there is a need for a fishing line cutter that is an integral part or section of the fishing pole. There is also a need for a fishing line cutter that can be used safely, minimizing the chance of injury to the user.

### SUMMARY OF EXEMPLARY EMBODIMENTS OF THE INVENTION

The present application is directed to fishing line cutters for cutting fishing line, and more particularly, to fishing line cutters that are integral to a fishing pole and are capable of cutting the fishing line when it is threaded on the fishing pole.

In one aspect, the fishing line cutter comprises a tubular section that is integrally attached to a fishing pole. The tubular section is located distally to a fishing reel on the fishing pole. An arcuate projection extends from the tubular section on the fishing pole. The arcuate projection is in a coplanar spatial orientation in relation to the fishing pole. The concave side of the arcuate projection faces the distal end of the fishing pole and comprises a sharpened edge for cutting the fishing line.

In another aspect, the fishing line cutter comprises a tubular section that is integrally attached to a fishing pole, and a slot is located on the tubular section. A spring means attaches the arcuate projection to the slot. At least one sharpening means is attached within the slot. An O-ring is wrapped around the fishing pole, and when slid distally on the fishing pole, depresses the arcuate projection into the slot. The sharpened edge of the arcuate projection is sharpened by the sharpening means when depressed into the interior of the fishing pole by the sliding of the O-ring.

In yet another aspect, the fishing line cutter includes a tubular section that is integrally attached to a fishing pole, a slot, and an O-ring that may include at least one sharpening means.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the present invention will become more fully understood from the detailed description and the accompanying drawings, wherein:

FIG. 1 is a perspective view of a first embodiment of a fishing line cutter according to the present invention.

FIG. 2 is a perspective view of a second embodiment of a fishing line cutter according to the present invention.

FIG. 3A is a perspective view of a third embodiment of a fishing line cutter according to the present invention.

FIG. 3B is a cross-sectional side view of the third embodiment illustrated in FIG. 3A along the center of the fishing pole, without O-ring slid over slot.

FIG. 3C is a cross-sectional side view of the third embodiment illustrated in FIG. 3A along the center of the fishing pole, with O-ring slid over slot.

FIG. 4A is a perspective view of a fourth embodiment of a fishing line cutter according to the present invention.

FIG. 4B is a cross-sectional side view of the fourth embodiment illustrated in FIG. 4A along the center of the fishing pole, without O-ring slid over slot.

FIG. 4C is a cross-sectional side view of the fourth embodiment illustrated in FIG. 4A along the center of the fishing pole with O-ring slid over slot.

### DETAILED DESCRIPTION OF EXEMPLARY EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any such alterations and further modifications in the illustrated devices, and such further applications of the principles of the invention as illustrated herein are contemplated as would normally occur to one skilled in the art to which the invention relates.

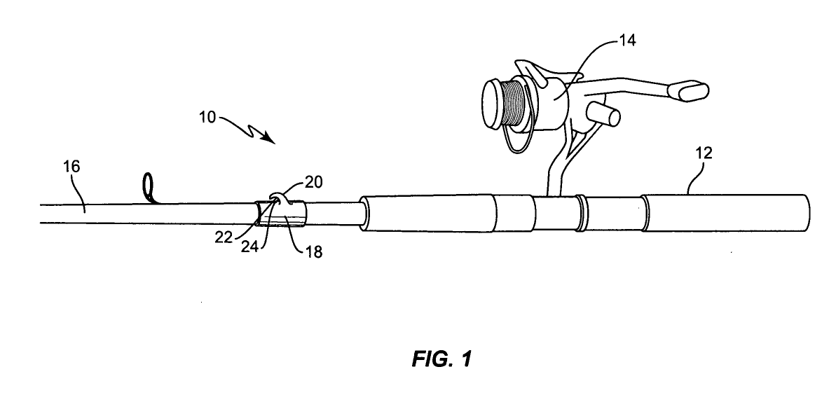

FIG. 1 illustrates a first embodiment of a fishing line cutter 10 described in the current application. In FIG. 1, the fishing line cutter 10 comprises a tubular section 18 that is integrally attached to a fishing pole 12. The tubular section 18 is distally located with respect to a reel 14 on the fishing pole 12. An arcuate projection 20 extends from the tubular projection 18. The tubular section 18 and the arcuate projection 20 may be fabricated from metals, plastics and reinforced plastics. The arcuate projection 20 may be located on the same side as the reel 14 and is spatially oriented, coplanar, to the fishing pole 12. The concave side 22 of the arcuate projection 20 faces the distal end 16 of the fishing pole 12 and includes a sharpened edge 24. A fishing line (not shown) may be cut by the sharpened edge 24 of the arcuate projection 20 when engaged by a fisherman.

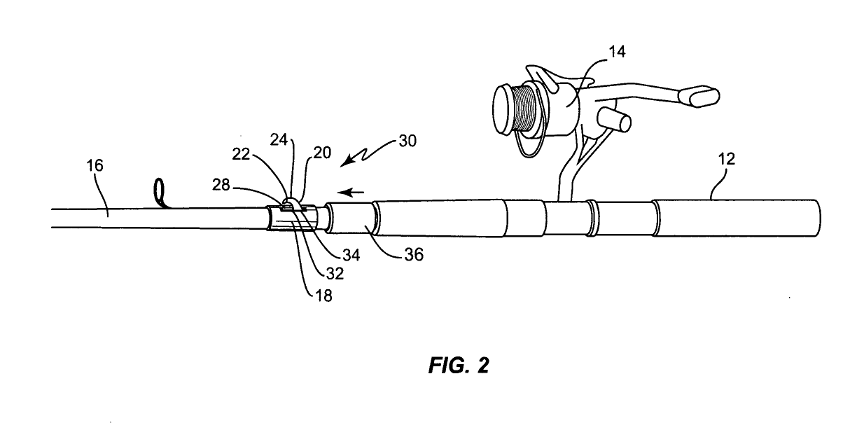

FIG. 2 illustrates a second embodiment of a fishing line cutter 30 described in the current invention. In FIG. 2, the fishing line cutter 30 comprises a tubular section 18 that is integrally attached to a fishing pole 12. An arcuate projection 20 extends from the tubular section 18 and includes a sharpened edge 24 on the concave side 22 as described above in FIG. 1. The tubular section 18 also includes a slot 32 that is juxtaposed and coplanar to the arcuate projection 20. The slot 32 is sized to accommodate the dimensions of the arcuate projection 20. A spring means 34 springingly attaches the arcuate projection 20 to the tubular section 18 at the slot 32. Depressing the arcuate projection 20 forces it into the slot 32 and into the interior 28 of the fishing pole 12. Thus, when not in use, the arcuate projection 20 may be stored in the interior 28 of the fishing pole 12. An O-ring 36, positioned juxtaposed to the slot 32 and distal to the reel 14, may be wrapped around the fishing pole 12. The O-ring 36 can slide along the fishing pole 12 and depress the arcuate projection 20 into the slot 32. The O-ring 36 also shields the arcuate projection 20 when the arcuate projection 20 is depressed into the interior 28 of the fishing pole 12. The O-ring 36, spring means 34, and the slot 32 may be fabricated from the same materials as the tubular section 18.

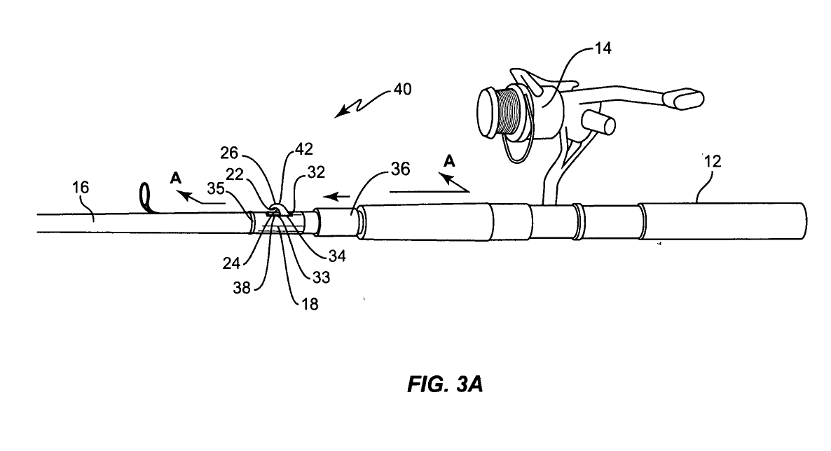

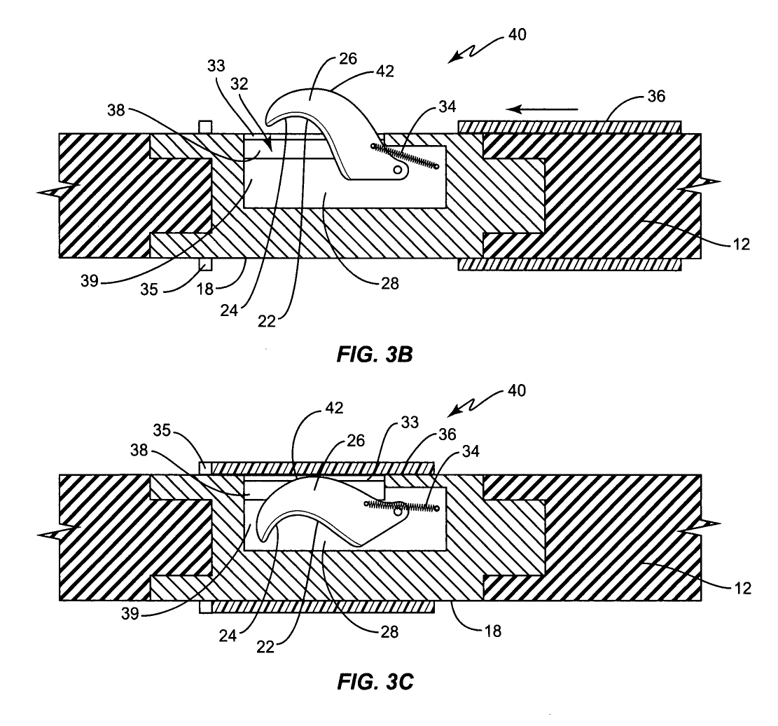

FIGS. 3A-3C illustrate a third embodiment of a fishing line cutter 40 described in the current invention. In FIG. 3A, a tubular section 18 is integrally attached to a fishing pole 12 and is distally located with respect to a reel 14. A metallic arcuate projection 26 extends from the tubular section 18. A spring means 34 springingly attaches the metallic arcuate projection 26 to a slot 32. The slot 32 includes at least one sharpening means 38. The sharpening means 38 is fixedly attached and coplanar to the slot 32. The slot 32 may include a pair of sharpening means 38 that can be fixedly attached to either side 33 of the slot 32. The pair of sharpening means 38 is distanced apart by a width of the concave side 22 of the metallic arcuate projection 26. When the metallic arcuate projection 26 is depressed it passes between the pair of sharpening means 38. As the metallic arcuate projection 26 is depressed into the slot 32, a sharpened edge 24 of the concave side 22 passes by and rubs against the at least one sharpening means 38 (see FIGS. 3B and 3C). The rubbing of the sharpened edge 24 with the at least one sharpening means 38, as the metallic arcuate projection 26 is depressed, maintains the sharpness of the sharpened edge 24. An O-ring 36 in this embodiment of the fishing line cutter 40 may be wrapped around the fishing pole 12 and located distal to the reel 14. The O-ring 36 can slide distally along the fishing pole 12 and contact the convex side 42 of the metallic arcuate projection 26 (see FIG. 3B). A first stop means 35 positioned at a distal end 39 of the slot 32 restricts further movement of the O-ring 36 distally along the fishing pole 12. As the O-ring 36 is slid further along the fishing pole 12 the metallic arcuate projection 26 is urged through the slot 32 and into the interior 28 of the fishing pole 12 (see FIG. 3C). The O-ring 36 may completely shroud the slot 32 when the O-ring 36 is slid to the first stop means 35 (see FIG. 3C).

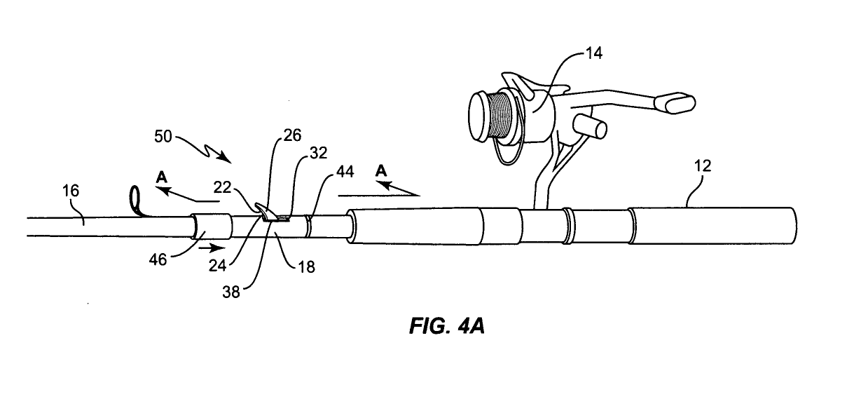

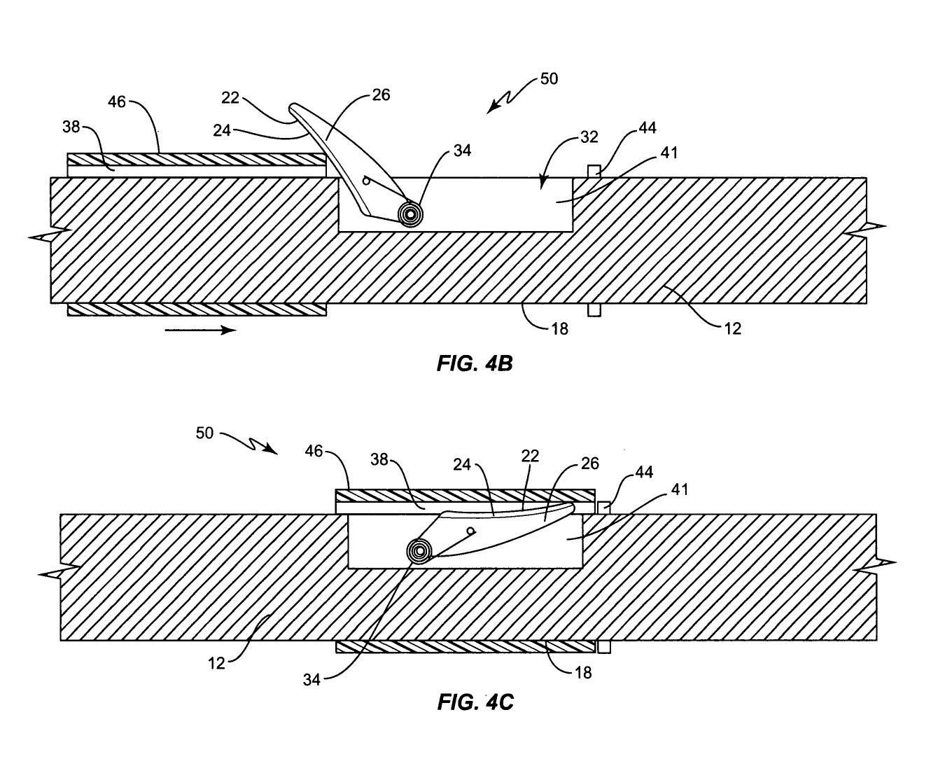

FIGS. 4A-4C illustrate a fourth embodiment of the fishing line cutter 50 described in the current invention. In FIG. 4A, a tubular section 18 is integrally attached to a fishing pole 12, distally with respect to a reel 14. A metallic arcuate projection 26 extends from the tubular section 18, as described above in FIGS. 3A-3C. A slot 32 is located on the tubular section 18, and a spring means 34 springingly attaches the metallic arcuate projection 26 to the slot 32 (see FIG. 4B). An O-ring 46 may be wrapped around the fishing pole 12 along the distal end 16 of the fishing pole 12 (see FIGS. 4A and 4B). At least one sharpening means 38 is fixedly attached within the O-ring 46. As described above in FIGS. 3A-3C, a pair of sharpening means 38 may be used. As the O-ring 46 is slid proximally along the fishing pole 12, towards the reel 14, a sharpened edge 24 of the concave side 22 of the metallic arcuate projection 26 rubs against the at least one sharpening means 38 and maintains the sharpness of the sharpened edge 24 (see FIG. 4B). By sliding the O-ring 46 proximally along the fishing pole 12 towards the reel 14, the metallic arcuate projection 26 is depressed into the slot 32, and the sharpening means 38 sharpens the sharpened edge 24 (see FIG. 4C). A second stop means 44 positioned at a proximal end 41 of the slot 32 restricts further movement of the O-ring 46 proximally along the fishing pole 12. The O-ring 46 may completely shroud the slot 32 when the O-ring 46 is slid to the second stop means 44.

The above description of embodiments of the invention is merely exemplary in nature and, thus, variations thereof are not to be regarded as a departure from the spirit and scope of the invention.

What is claimed is:

1. A fishing line cutter, comprising:
a tubular section integrally attached to a fishing pole and distally located with respect to a reel; and
an arcuate projection extending from said tubular section in a coplanar spatial orientation to the fishing pole; and
wherein the concave side of said arcuate projection includes a sharpened edge facing the distal end of the fishing pole.

2. The fishing line cutter of claim 1, wherein said tubular section includes metals, plastics and reinforced plastics.

3. A fishing line cutter, comprising:
a tubular section integrally attached to a fishing pole and distally located with respect to a reel;
an arcuate projection extending from said tubular section on a same side as the reel and coplanar to the fishing pole, and wherein
the concave side of said arcuate projection includes a sharpened edge facing the distal end of the fishing pole;
a slot located on said tubular section, juxtaposed, and coplanar to said arcuate projection, and below the concave side;
a spring means springingly attaching said arcuate projection to said tubular section via said slot; and
an O-ring wrapped around the fishing pole, juxtaposed to said slot and distal to the reel.

4. The fishing line cutter of claim 4, wherein said slot is dimensioned to accommodate said arcuate projection.

5. The fishing line cutter of claim 4, wherein said spring means includes fabrication from metals, plastics and reinforced plastics.

6. The fishing line cutter of claim 4, wherein said tubular section comprises fabrication from metals, plastics and reinforced plastics.

7. The fishing line cutter of claim 4, wherein said arcuate projection comprises fabrication from metals, plastics and reinforced plastics.

8. The fishing line cutter of claim 4, wherein said O-ring comprises fabrication from metals, plastics and reinforced plastics.

9. The fishing line cutter of claim 4, wherein said O-ring is dimensioned to at least cover said slot and not exceed said tubular section.

10. A fishing line cutter, comprising:
a tubular section integrally attached to a fishing pole and distally located with respect to a reel;
a metallic arcuate projection extending from said tubular section on a same side as the reel and in a coplanar spatial orientation to the fishing pole, and wherein the concave side of said metallic arcuate projection includes a sharpened edge facing the distal end of the fishing pole;
a slot located on said tubular section, juxtaposed and coplanar to said metallic arcuate projection, and below the concave side;
at least one sharpening means fixedly attached within, and coplanar to said slot;
a spring means springingly attaching said metallic arcuate projection to one end of said slot;
an O-ring wrapped around the fishing pole, juxtaposed to said slot and distal to the reel, whereby sliding said O-ring distally on the fishing rod depresses said metallic arcuate projection into said slot and against said at least one sharpening means; and
a first stop means juxtaposed to a distal end of said slot.

11. The fishing line cutter of claim 11, further comprising a pair of at least one sharpening means fixedly attached on either side and coplanar to said slot, and distanced apart by a width of the concave side of said metallic arcuate projection.

12. The fishing line cutter of claim 11, wherein said tubular section comprises fabrication from metals, plastics and reinforced plastics.

13. The fishing line cutter of claim 11, wherein said O-ring comprises fabrication from metals, plastics and reinforced plastics.

14. The fishing line cutter of claim 11, wherein said spring means comprises fabrication from metals, plastics and reinforced plastics.

15. The fishing line cutter of claim 11, wherein said O-ring comprises fabrication to slide distally from the reel along the fishing pole, depressing the convex side of said metallic arcuate projection and urging the concave side of the metallic arcuate projection against said sharpening means and into said slot.

16. A fishing line cutter, comprising:
a tubular section integrally attached to a fishing pole and distally located with respect to a reel;
a metallic arcuate projection extending from said tubular section located on a same side as the reel and coplanar to the fishing pole, and wherein the concave side of said metallic arcuate projection comprises a sharpened edge facing the distal end of the fishing pole;
a slot located on said tubular section, juxtaposed and coplanar to said metallic arcuate projection, and below the concave side;
a spring means springingly attaching said metallic arcuate projection to one end of said slot;
an O-ring wrapped around the fishing pole, juxtaposed to said slot and distal to the reel;
at least one sharpening means fixedly attached within said O-ring, and coplanar to said slot, whereby sliding said O-ring proximally on the fishing rod depresses said metallic arcuate projection into said slot and against said at least one sharpening means; and
a second stop means juxtaposed to a proximal end of said slot.

17. The fishing line cutter of claim 16, further comprising a pair of at least one sharpening means fixedly attached within said O-ring, and wherein said pair of sharpening means are distanced apart by a width of said concave side of said metallic arcuate projection.

18. The fishing line cutter of claim 16, wherein said tubular section comprises fabrication from metals, plastics and reinforced plastics.

19. The fishing line cutter of claim 16, wherein said spring means comprises fabrication from metals, plastics and reinforced plastics.

20. A method for cutting a fishing line, said method comprising:
positioning a tubular section integrally attached to a fishing pole, distally to a reel;
extending an arcuate projection from said tubular section and coplanar to the fishing pole; and
positioning a sharpened edge of the concave side of said arcuate projection to face towards the distal end of the fishing pole.
